(19) United States
(12) Patent Application Publication
(10) Pub. No.: US 2023/0117456 A1
(43) Pub. Date: Apr. 20, 2023

(54) OPTICAL LOGIC ELEMENT FOR PHOTOELECTRIC DIGITAL LOGIC OPERATION AND LOGIC OPERATION METHOD THEREOF

(71) Applicant: TSINGHUA UNIVERSITY, Beijing (CN)

(72) Inventors: Qionghai DAI, Beijing (CN); Jiyuan ZHENG, Beijing (CN); Chenchen DENG, Beijing (CN); Jiamin WU, Beijing (CN)

(21) Appl. No.: 17/964,845

(22) Filed: Oct. 12, 2022

(30) Foreign Application Priority Data
Oct. 14, 2021 (CN) 202111198459.3

(51) Int. Cl. H04B 10/556

(52) U.S. Cl. CPC H04B 10/556

(57) ABSTRACT

The present disclosure relates to optical logic element technologies, and more particularly, to an optical logic element for photoelectric digital logic operation and a logic operation method thereof. Here, the element includes a driver member configured to drive a photoelectric integrated member, generate digital modulation information that is capable of being recognized by the photoelectric integrated member, and read an electrical signal outputted by the photoelectric integrated member; and the photoelectric integrated member configured to carry, by using a coherent optical signal, the digital modulation information inputted by the drive member, and perform, in a predetermined optical diffraction neural network, a digital logic operation on the coherent optical signal to obtain an operation result, generate, from the operation result based on a digital logic mapping relationship, the electrical signal, and output, after reading the electrical signal by using the drive member, the operation result.

### CROSS-REFERENCE TO RELATED APPLICATION

The present application claims a priority of a Chinese Patent Application No. CN 202111198459.3, filed on Oct. 14, 2021, which is hereby incorporated by reference in its entirety.

### TECHNICAL FIELD

The present disclosure relates to optical logic element technologies, and more particularly, to an optical logic element for photoelectric digital logic operation and a logic operation method thereof.

### BACKGROUND

In an era of new industrial revolution driven by data, computing power is the first productivity. At present, with the development of an artificial intelligence technology, a corresponding artificial intelligence algorithm becomes more and more complex. At present, a density and size of devices on conventional micro-nano electronic chips have approached a physical limit. Power consumption and the computing power also face a bottleneck. Photoelectric calculation makes full use of dual advantages of light in the computing power and energy consumption and has a potential to solve a bottleneck of computing power and power consumption faced by current large-scale calculation. A photoelectric intelligent chip can bring more than three orders of magnitude improvement in the computing power and scale performance in various fields such as intelligent city, intelligent traffic, intelligent security, cloud computing and data center, and national defense, etc.

A photoelectric digital logic operation chip is an important component for realizing photoelectric intelligent calculation. At present, there are various implementation paths. An optical digital logic gate may be realized by nonlinear devices such as a semiconductor optical amplifier, a periodically polarized lithium niobate waveguide, and an electro-absorption modulator, but have non-ideal unit calculated energy consumption, noise and other performances, and a limited integration potential. In terms of integrated optical calculation, an international representative work mainly includes a silicon-photonics-based optical interference network array implementing matrix numerical calculation, an optical phase change material array implementing storage and calculation integrated framework, and the like. Similar work implements a part of simple optical calculation. However, a current silicon-photonics scheme has problems such as low parameter scale, simpler model framework, etc. A spatial optical-based photoelectric Fourier domain convolutional neural network realizes high-throughput optical calculation, but has a limited system modulation rate and errors that are difficult to correct. The related art lacks a logic operation device that may perform a large-scale operation and have a high modulation rate, which needs to be solved urgently.

### SUMMARY

The present disclosure provides an optical logic element for photoelectric digital logic operation and a logic operation method thereof, which implements a high-speed photoelectric logic calculation chip through an artificial intelligent method, and provides a logic element that has a large operation scale, a high modulation rate, and is capable of performing different operation logic.

According to the embodiments in a first aspect of the present disclosure, the optical logic element for photoelectric digital logic operation is provided. The optical logic element for photoelectric digital logic operation includes: a driver member, a photoelectric integrated member. The driver member is configured to drive the photoelectric integrated member, generate digital modulation information that is capable of being recognized by the photoelectric integrated member, and read an electrical signal outputted by the photoelectric integrated member. The photoelectric integrated member is configured to carry, by using a coherent optical signal, the digital modulation information inputted by the drive member, and perform, in a predetermined optical diffraction neural network, a digital logic operation on the coherent optical signal to obtain an operation result, generate, from the operation result based on a digital logic mapping relationship, the electrical signal, and output, after reading the electrical signal by using the drive member, the operation result.

According to the embodiments of the present disclosure, the photoelectric integrated member includes a laser, an optical splitter member, a modulator set, a micro-nano optical diffraction line array and a detector array. The laser is configured to generate, based on a first drive signal transmitted by the drive member, the coherent optical signal. The optical splitter member is configured to split the coherent optical signal into at least one beam of coherent optical signal. The modulator set is configured to load the digital modulation information onto the at least one beam of coherent optical signal to obtain the coherent optical signal loaded with the digital modulation information. The micro-nano optical diffraction line array is configured to perform, by using the predetermined optical diffraction neural network generated by the micro-nano optical diffraction line array, the digital logic operation on the coherent optical signal to output the operation result. The detector array is configured to generate, based on the operation result, the electrical signal.

According to the embodiments of the present disclosure, the optical splitter member includes a waveguide and a beam splitter. The waveguide is configured to guide the coherent optical signal. The beam splitter is configured to beam-split the guided coherent optical signal.

According to the embodiments of the present disclosure, an array structure of the micro-nano optical diffraction line array is determined by a digital logic operation function corresponding to the predetermined optical diffraction neural network.

According to the embodiments of the present disclosure, the array structure of the micro-nano optical diffraction line array is adjusted by one or more of the number of diffraction lines, a spacing between the diffraction lines, a thickness of each diffraction line, a width of each diffraction line, a length of each diffraction line, or a root-mean-square roughness of the thickness, width, and length of each diffraction line.

According to the embodiments of the present disclosure, the drive member includes a first drive sub-member, a second drive sub-member, a third drive sub-member and a reading sub-member. The first drive sub-member is configured to generate the first drive signal that drives the laser to generate the coherent optical signal. The second drive sub-member is configured to generate a second drive signal that drives the modulator set to load the digital modulation information. The third drive sub-member is configured to generate a third drive signal that drives the detector array to generate the electrical signal. The reading sub-member is configured to read the electrical signal from the detector array, and output the operation result based on the electrical signal.

According to the embodiments of the present disclosure, at least one modulator is provided in the modulator set.

According to the embodiments of the present disclosure, the drive member and the photoelectric integrated member are arranged integrally.

According to the embodiments of the present disclosure, a loading timing for loading the digital modulation information by the photoelectric integrated member includes synchronization and asynchronization.

According to the embodiments in a second aspect of the present disclosure, a photoelectric digital logic operation method is provided and is used by the optical logic element for photoelectric digital logic operation according to the above embodiments. The photoelectric digital logic operation method includes: determining the digital modulation information; driving the digital modulation information to be loaded onto the coherent optical signal to obtain the coherent optical signal loaded with the digital modulation information; and performing, in the predetermined optical diffraction neural network, the digital logic operation on the coherent optical signal to obtain the operation result, generating, from the operation result based on the digital logic mapping relationship, the electrical signal, and outputting, based on the electrical signal, the operation result.

According to the optical logic element for photoelectric digital logic operation and the logic operation method thereof in the embodiments of the present disclosure, the digital modulation information is determined by the driver member and is driven by the driver member to be loaded onto the coherent optical signal generated by the photoelectric integrated member; and the photoelectric integrated member performs the digital logic operation on the modulated coherent optical signal in the predetermined optical diffraction neural network to obtain the operation result, generates the electrical signal from the operation result based on the digital logic mapping relationship, and outputs the operation result after reading the electrical signal by using the drive member, thereby realizing hybrid integrated photoelectric logic calculation, having higher unit energy consumption calculation performance (FLOPs/J), being capable of reconstructing and designing different dedicated logical operations in batches, and having the large operation scale and the high modulation rate.

Additional aspects and advantages of the present disclosure will be provided in part in the following description, or will become apparent in part from the following description or can be learned from practice of the present disclosure.

### BRIEF DESCRIPTION OF DRAWINGS

The above and/or additional aspects and advantages of the present disclosure will become more apparent and more understandable from the description of embodiments taken in conjunction with the accompanying drawings.

FIG. 1 is a schematic structural view showing an optical logic element for photoelectric digital logic operation according to an embodiment of the present disclosure.

FIG. 2 is a specifically schematic structural view showing an optical logic element for photoelectric digital logic operation according to an embodiment of the present disclosure.

FIG. 3 is a schematic top structural view showing a photoelectric integrated member according to an embodiment of the present disclosure.

FIG. 4 is a schematic three-dimensional side structural view showing a photoelectric integrated member according to an embodiment of the present disclosure.

FIG. 5 is another specifically schematic structural view showing an optical logic element for photoelectric digital logic operation according to an embodiment of the present disclosure.

FIG. 6 is a flowchart showing a photoelectric digital logic operation method according to an embodiment of the present disclosure.

Reference numerals in the accompanying drawings: 100-driver member, 101-first drive sub-member, 102-second drive sub-member, 103-third drive sub-member, 104-reading sub-member, 200-photoelectric integrated member, 201-laser, 202-optical splitter member, 203-modulator set, 204-micro-nano optical diffraction line array, 205-detector array.

### DESCRIPTION OF EMBODIMENTS

The embodiments of the present disclosure are described in detail below, examples of which are illustrated in the accompanying drawings, through which the same or similar reference numerals refer to the same or similar elements or elements having the same or similar functions. The embodiments described below with reference to the accompanying drawings are exemplary, and are intended to be used to explain the present disclosure, but should not be construed as a limitation to the present disclosure.

An optical logic element for photoelectric digital logic operation and a logic operation method thereof according to the embodiments of the present disclosure are described below with reference to the accompanying drawings. In view of a problem of lacking a logic computing device that is capable of performing a large-scale operation and has a high modulation rate mentioned in the foregoing background, the optical logic element for photoelectric digital logic operation and the logic operation method thereof are provided in the present disclosure, which includes that digital modulation information is determined by a driver member and is driven by the driver member to be loaded onto a coherent optical signal generated by a photoelectric integrated member; and the photoelectric integrated member performs a digital logic operation on the modulated coherent optical signal in a predetermined optical diffraction neural network to obtain an operation result, generates an electrical signal from the operation result based on a digital logic mapping relationship, and outputs the operation result after reading the electrical signal by using the drive member, thereby realizing the hybrid integrated photoelectric logic calculation, having higher unit energy consumption calculation performance (FLOPs/J), being capable of reconstructing and designing different dedicated logical operations in batches, and having the large operation scale and the high modulation rate.

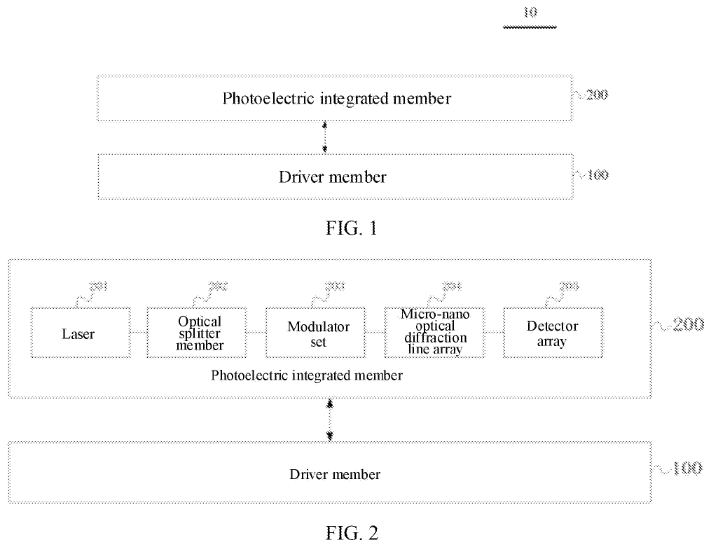

Specifically, FIG. 1 is a schematic structural view showing an optical logic element for photoelectric digital logic operation according to an embodiment of the present disclosure.

As illustrated in FIG. 1, the optical logic element for photoelectric digital logic operation includes a driver member 100 and a photoelectric integrated member 200.

Here, the driver member 100 is configured to drive the photoelectric integrated member 200, generate digital modulation information that is capable of being recognized by the photoelectric integrated member 200, and read an electrical signal outputted by the photoelectric integrated member 200. The photoelectric integrated member 200 is configured to carry, by using the coherent optical signal, the digital modulation information inputted by the drive member 100, and perform, in a predetermined optical diffraction neural network, a digital logic operation on the coherent optical signal to obtain an operation result, generate, from the operation result based on a digital logic mapping relationship, the electrical signal, and output, after reading the electrical signal by using the drive member 100, the operation result.

It can be understood that the optical logic element for photoelectric digital logic operation of the present disclosure is hybrid integrated by using the driving member 100 and the photoelectric integrated member 200. An integrated method includes, but is not limited to, Wafer Bonding, Die Bonding, Wire Bonding, Flip Chip Bonding, etc.

According to the embodiments of the present disclosure, the photoelectric integrated member 200 includes a laser 201, an optical splitter member 202, a modulator set 203, a micro-nano optical diffraction line array 204 and a detector array 205. The laser 201 is configured to generate, based on a first drive signal transmitted by the drive member 100, the coherent optical signal. The optical splitter member 202 is configured to split the coherent optical signal into at least one beam of coherent optical signal. The modulator set 203 is configured to load the digital modulation information onto the at least one beam of coherent optical signal to obtain the coherent optical signal loaded with the digital modulation information. The micro-nano optical diffraction line array 204 is configured to perform, by using the predetermined optical diffraction neural network generated by the micro-nano optical diffraction line array, the digital logic operation on the coherent optical signal to output the operation result. The detector array 205 is configured to generate, based on the operation result, the electrical signal.

As illustrated in FIG. 2, a specific structure of the optical logic element for photoelectric digital logic operation is illustrated. According to a signal transmission direction, the photoelectric integrated member 200 sequentially includes the laser 201, the optical splitter member 202, the modulator set 203, the micro-nano optical diffraction line array 204 and the detector array 205.

Specifically, the laser 201 emits the coherent optical signal based on the first drive signal of the drive member 100. In a specific embodiment, the laser 201 includes, but is not limited to, a Distributed Feedback Laser (DFB), a Micro-ring laser, a Vertical-Cavity Surface-Emitting Laser (VCSEL), and an LP laser. A center wavelength includes, but is not limited to, a wavelength of ultraviolet light, visible light, and infrared light. A material for the laser includes, but is not limited to, InGaAs, AlAsP, GaAs, GaN, InGaN, AlGaN, and the like. A structure for the laser includes, but is not limited to, multiple quantum wells, a quantum dot, etc.

According to the embodiments of the present disclosure, the optical splitter member 202 includes a waveguide and a beam splitter. The waveguide is configured to guide the coherent optical signal. The beam splitter is configured to beam-split the guided coherent optical signal.

Specifically, after the coherent optical signal is emitted by the laser 201, the coherent optical signal is guided and beam-split by the optical splitter member 202. In a specific embodiment of the present disclosure, the optical splitter member 202 may include the waveguide and the beam splitter. Other devices that may be used to beam-split the coherent optical signal may also be applied in the embodiments of the present disclosure, which are not specifically limited.

In some embodiments, a waveguide center wavelength of the waveguide and the beam splitter includes, but is not limited to, the wavelength of ultraviolet light, visible light, and infrared light. A mode includes, but is not limited to, a single mode and a multi-mode. The beam splitter divides the coherent optical signal into at least one beam of coherent optical signal. A beam splitting form includes, but is not limited to, a Y-Splitter, a Multi-Mode Inferometer (MMI), etc.

According to the embodiments of the present disclosure, at least one modulator is provided in the modulator set 203.

It can be understood that the modulator set 203 loads the digital modulation information onto the at least one beam of coherent optical signal. In order to modulate the at least one beam of coherent optical signal, the modulator set includes at least one modulator.

In some embodiments, the modulator includes, but is not limited to, a Franz-Kedysh effect and Stark effect modulator, a Mach-Zehnder modulator, an electro-absorption modulator, etc. Here, a modulation bandwidth of the modulator is H (H>0 Hz).

According to the embodiments of the present disclosure, a loading timing for loading the digital modulation information by the photoelectric integrated member 200 includes synchronization and asynchronization.

According to the embodiments of the present disclosure, an array structure of the micro-nano optical diffraction line array 204 is determined by a digital logic operation function corresponding to the predetermined optical diffraction neural network.

The optical logic element in the embodiments of the present disclosure may realize a plurality of different photoelectric digital logic operations. A calculation portion of the photoelectric digital logic operation is composed of a series of micro-nano optical diffraction line arrays 204 having a same length, spacing and average thickness. Each diffraction line is engraved with a different pre-designed diffraction pattern. As a specific implementation, the embodiments of the present disclosure realize a digital logic operation function corresponding to the predetermined optical diffraction neural network by changing the array structure of the micro-nano optical diffraction line array 204. The digital logic operation function includes, but is not limited to, a full adder, a shifter, a basic logic gate such as an and gate, a not gate, and an or gate, and other combinational logic calculations.

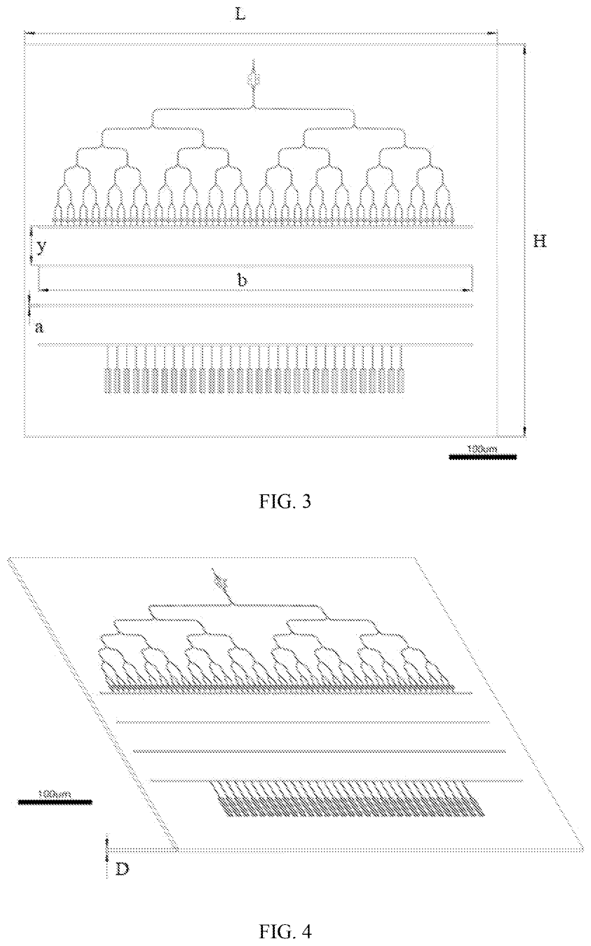

Taking a digital logic operation function of the full adder as an example, a full adding logic calculation is implemented. FIG. 3 and FIG. 4 show a top-view structure and a three-dimensional side-view structure of a photoelectric integrated member 200 in the full adder. A length and a width of the single photoelectric integrated member 200 are L and H respectively. A thickness of a substrate is D. An information transmission direction from top to bottom is respectively composed of the laser, the waveguide and a beam splitter array, the modulator set, the micro-nano optical diffraction line array and the detector array. An average thickness of each diffraction line of the micro-nano optical diffraction line array is a. A length of each diffraction line of the micro-nano optical diffraction line array is b. A width of each diffraction line of the micro-nano optical diffraction line array is c. A spacing between diffraction lines is y. The number of the diffraction lines is x (not labeled in the figure). Diffraction calculation is completed by a surface fluctuation of the diffraction line.

According to the embodiments of the present disclosure, the array structure of the micro-nano optical diffraction line array is adjusted by one or more of the number of diffraction lines, the spacing between the diffraction lines, the thickness of each diffraction line, the width of each diffraction line, the length of each diffraction line, or a root-mean-square roughness of the thickness, width, and length of each diffraction line.

Specifically, the array structure of the micro-nano optical diffraction line array includes one or more of the following eight sets of variables: the number of micro-nano optical diffraction lines x (x>0); the spacing every two micro-nano optical diffraction line y (1,000,000 nm>y>1 nm); the thickness of each diffraction line z (1,000,000 nm>z>1 nm); the width of each diffraction line a (1,000,000 nm>a>1 nm); the length of each diffraction line b (1,000,000 nm>b>1 nm); and the root-mean-square roughness of z, a, b is c_{z}, cₐ, c_{b} (1,000,000 nm>c_{z}, cₐ, c_{b}>1 nm). By changing the parameters of the above variables, the array structure of the micro-nano optical diffraction line array is changed to implement different photoelectric logic operations. A design method of the diffraction line in the array structure includes, but is not limited to, a neural network backpropagation method, a physical optical calculation method, etc.

In some embodiments, preparation material of the micro-nano optical diffraction line array includes, but is not limited to, SiO₂, SiNₓ, Si, GaN, AlN, etc.

According to the embodiments of the present disclosure, the drive member 100 includes a first drive sub-member 101, a second drive sub-member 102, a third drive sub-member 103 and a reading sub-member 104. The first drive sub-member 101 is configured to generate the first drive signal that drives the laser to generate the coherent optical signal. The second drive sub-member 102 is configured to generate a second drive signal that drives the modulator set to load the digital modulation information. The third drive sub-member 103 is configured to generate a third drive signal that drives the detector array to generate the electrical signal. The reading sub-member 104 is configured to read the electrical signal from the detector array, and output the operation result based on the electrical signal.

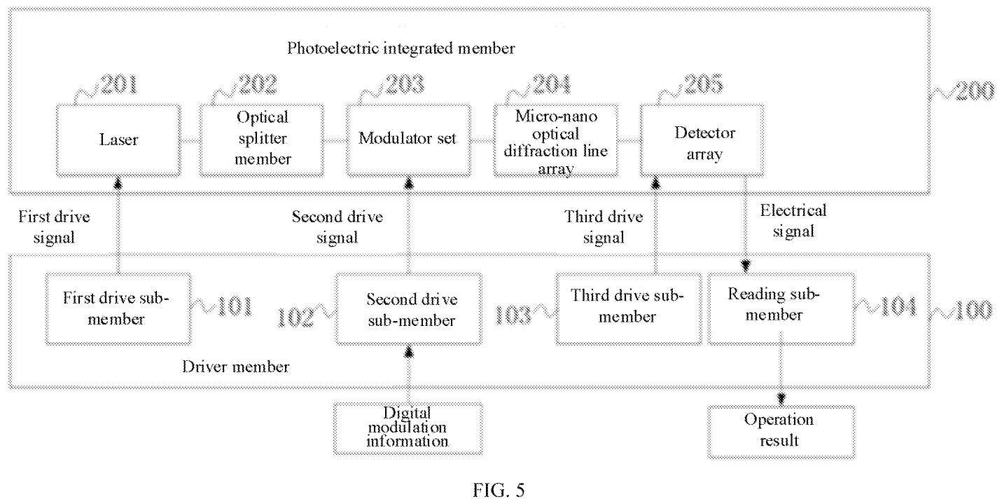

Specifically, the drive member 100 may provide energy driving, digital signal loading, and signal reading for the photoelectric integrated member 200. As illustrated in FIG. 5, the first drive sub-member 101 is connected to the laser 201 and uses the first drive signal to drive the laser 201 to generate the coherent optical signal. The second drive sub-member 102 is connected to the modulator set 203 and drives the digital modulation information to be loaded onto the coherent optical signal by using the second drive signal. The third drive sub-member 103 and the reading sub-member 104 are connected to the detector array 205, uses the third drive signal to drive the detector array 205 to perform photoelectric conversion, to convert the operation result of the micro-nano optical diffraction line array 204 into the electrical signal, and reads the electrical signal by the reading sub-member 104 to obtain a final operation result.

In some embodiments, the drive member 100 includes, but is not limited to, a high-speed analog-to-digital converter, a high-speed digital-to-analog converter, a power amplifier, a transconductance amplifier, etc.

It can be understood that the optical logic element in the above embodiments may be processed through a silicon-based optoelectronic technique, for example, the micro-nano optical diffraction line array may be obtained by etching a corresponding material. An etching method includes, but is not limited to, a wet etching and a dry etching.

In a specific embodiment of the present disclosure, two paths of N-bit logic input signals are inputted in parallel by the drive member 100 to corresponding 2*N modulator sets. A laser signal is loaded on a direct-current laser generated by the laser and a waveguide beam splitter. Optical diffraction propagation calculation is performed through the micro-nano optical diffraction line array. Here a specific diffraction pattern is engraved on the diffraction line, which is capable of calculating the input into a corresponding N-bit optical signal result. After the detector array composed of N detectors performs photoelectric activation and detection, a digital signal is read from the drive member 100.

According to the optical logic element for photoelectric digital logic operation and the logic operation method thereof in the embodiments of the present disclosure, the digital modulation information is determined by the driver member and is driven by the driver member to be loaded onto the coherent optical signal generated by the photoelectric integrated member; and the photoelectric integrated member performs the digital logic operation on the modulated coherent optical signal in the predetermined optical diffraction neural network to obtain the operation result, generates the electrical signal from the operation result based on the digital logic mapping relationship, and outputs the operation result after reading the electrical signal by using the drive member, thereby realizing the hybrid integrated photoelectric logic calculation, having higher unit energy consumption calculation performance, being capable of reconstructing and designing different dedicated logical operations in batches, and having the large operation scale and the high modulation rate.

Next, the photoelectric digital logic operation method according to the embodiments of the present disclosure is described with reference to the accompanying drawings.

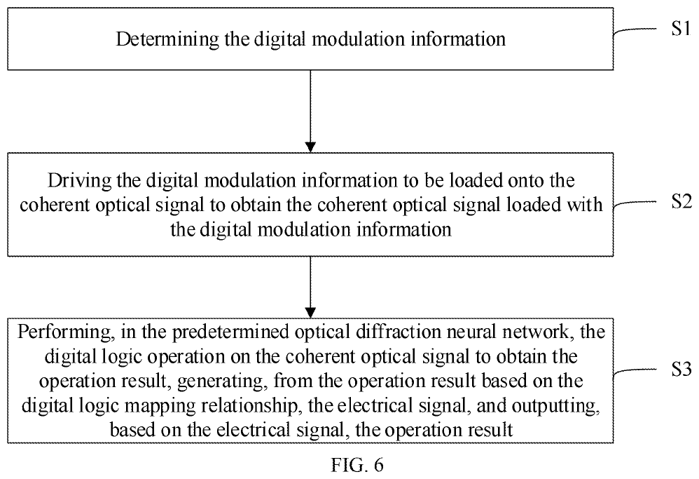

FIG. 6 is a flowchart showing a photoelectric digital logic operation method according to an embodiment of the present disclosure.

As illustrated in FIG. 6, the photoelectric digital logic operation method adopts the optical logic element for the photoelectric digital logic operation in the above embodiments, which specifically includes the following actions. At block S1, the digital modulation information is determined.

At block S2, the digital modulation information is driven to be loaded onto the coherent optical signal. The coherent optical signal loaded with the digital modulation information is obtained.

At block S3, the digital logic operation is performed on the coherent optical signal in the predetermined optical diffraction neural network to obtain the operation result. The electrical signal is generated from the operation result based on the digital logic mapping relationship. The operation result is outputted based on the electrical signal.

It should be noted that the foregoing explanation of the optical logic element embodiments for the photoelectric digital logic operation is also applicable to the photoelectric digital logic operation method in the embodiments, and details are not described herein again.

According to the photoelectric digital logic operation method in the embodiments of the present disclosure, the digital modulation information is determined and is driven to be loaded onto the coherent optical signal to obtain the coherent optical signal loaded with the digital modulation information; and the digital logic operation is performed on the coherent optical signal in the predetermined optical diffraction neural network to obtain the operation result, the electrical signal is generated from the operation result based on the digital logic mapping relationship, and the operation result is outputted based on the electrical signal, thereby realizing the hybrid integrated photoelectric logic calculation, having higher unit energy consumption calculation performance (FLOPs/J), being capable of reconstructing and designing different dedicated logical operations in batches, and having the large operation scale and the high modulation rate.

In the description of this specification, descriptions with reference to the terms “an embodiment”, “some embodiments”, “examples”, “specific examples”, or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or N embodiments or examples in a suitable manner. In addition, those skilled in the art can combine the different embodiments or examples and the features of the different embodiments or examples described in this specification without contradicting each other.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “N” means at least two, such as two or three, unless otherwise specifically defined.

Any procedure or method described in the flowcharts or described in any other way herein may be understood to include one or more N modules, portions or parts of codes of executable instructions that realize actions of particular logic functions or procedures. Moreover, advantageous embodiments of the present disclosure include other implementations in which functions are executed in the order different from which is depicted or discussed, including in a substantially simultaneous manner or in an opposite order according to the related functions, which should be understood by those skilled in the art.

The logic and/or step described in other manners herein or shown in the flowchart, for example, a particular sequence table of executable instructions for realizing the logical function, may be specifically realized in any computer readable medium to be used by the instruction execution system, device or equipment (such as the system based on computers, the system including processors or other systems capable of obtaining the instructions from the instruction execution system, device and equipment and executing the instructions), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium include but are not limited to: an electronic connection (an electronic device) with one or N wires, a portable computer disk case (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of being printed with programs thereon, this is because, for example, the paper or other appropriate medium may be optically scanned and then edited, decrypted or processed with other appropriate methods when necessary to obtain the programs in an electric manner, and then the programs may be stored in the computer memory.

It should be understood that each part of the present disclosure may be realized by the hardware, software, firmware or their combination. In the above embodiments, N steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above method of the embodiments of the present disclosure may be achieved by instructing the related hardware by programs. The programs may be stored in a computer readable storage medium, and the programs include one or a combination of the steps in the method embodiments of the present disclosure when run on a computer.

In addition, each function cell of the embodiments of the present disclosure may be integrated in a processing module, or these cells may exist separately physically, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc. Although embodiments according to the present disclosure have been shown and described, it would be appreciated by those skilled in the art that the above embodiments are illustrative and cannot be construed to limitation on the present disclosure, and changes, alternatives, modifications, and variations can be made in the embodiments without departing from scope of the present disclosure.

What is claimed is:

1. An optical logic element for photoelectric digital logic operation, the optical logic element comprising:
a driver member configured to drive a photoelectric integrated member, generate digital modulation information that is capable of being recognized by the photoelectric integrated member, and read an electrical signal outputted by the photoelectric integrated member; and
the photoelectric integrated member configured to carry, by using a coherent optical signal, the digital modulation information inputted by the drive member, and perform, in a predetermined optical diffraction neural network, a digital logic operation on the coherent optical signal to obtain an operation result, generate, from the operation result based on a digital logic mapping relationship, the electrical signal, and output, after reading the electrical signal by using the drive member, the operation result.

2. The optical logic element according to claim 1, wherein the photoelectric integrated member comprises:
a laser configured to generate, based on a first drive signal transmitted by the drive member, the coherent optical signal;
an optical splitter member configured to split the coherent optical signal into at least one beam of coherent optical signal;
a modulator set configured to load the digital modulation information onto the at least one beam of coherent optical signal to obtain the coherent optical signal loaded with the digital modulation information;
a micro-nano optical diffraction line array configured to perform, by using the predetermined optical diffraction neural network generated by the micro-nano optical diffraction line array, the digital logic operation on the coherent optical signal to output the operation result; and
a detector array configured to generate, based on the operation result, the electrical signal.

3. The optical logic element according to claim 2, wherein the optical splitter member comprises:
a waveguide configured to guide the coherent optical signal; and
a beam splitter configured to beam-split the guided coherent optical signal.

4. The optical logic element according to claim 2, wherein an array structure of the micro-nano optical diffraction line array is determined by a digital logic operation function corresponding to the predetermined optical diffraction neural network.

5. The optical logic element according to claim 4, wherein the array structure of the micro-nano optical diffraction line array is adjusted by one or more of the number of diffraction lines, a spacing between the diffraction lines, a thickness of each diffraction line, a width of each diffraction line, a length of each diffraction line, or a root-mean-square roughness of the thickness, width, and length of each diffraction line.

6. The optical logic element according to claim 2, wherein the drive member comprises:
a first drive sub-member configured to generate the first drive signal that drives the laser to generate the coherent optical signal;
a second drive sub-member configured to generate a second drive signal that drives the modulator set to load the digital modulation information;
a third drive sub-member configured to generate a third drive signal that drives the detector array to generate the electrical signal; and
a reading sub-member configured to read the electrical signal from the detector array, and output the operation result based on the electrical signal.

7. The optical logic element according to claim 2, wherein at least one modulator is provided in the modulator set.

8. The optical logic element according to claim 1, wherein the drive member and the photoelectric integrated member are arranged integrally.

9. The optical logic element according to claim 1, wherein a loading timing for loading the digital modulation information by the photoelectric integrated member comprises synchronization and asynchronization.

10. A photoelectric digital logic operation method, using the optical logic element for photoelectric digital logic operation according to claim 1, the method comprising:
determining the digital modulation information;
driving the digital modulation information to be loaded onto the coherent optical signal to obtain the coherent optical signal loaded with the digital modulation information; and
performing, in the predetermined optical diffraction neural network, the digital logic operation on the coherent optical signal to obtain the operation result, generating, from the operation result based on the digital logic mapping relationship, the electrical signal, and outputting, based on the electrical signal, the operation result.

11. The method according to claim 10, wherein the photoelectric integrated member comprises:
a laser configured to generate, based on a first drive signal transmitted by the drive member, the coherent optical signal;
an optical splitter member configured to split the coherent optical signal into at least one beam of coherent optical signal;
a modulator set configured to load the digital modulation information onto the at least one beam of coherent optical signal to obtain the coherent optical signal loaded with the digital modulation information;
a micro-nano optical diffraction line array configured to perform, by using the predetermined optical diffraction neural network generated by the micro-nano optical diffraction line array, the digital logic operation on the coherent optical signal to output the operation result; and
a detector array configured to generate, based on the operation result, the electrical signal.

12. The method according to claim 11, wherein the optical splitter member comprises:
a waveguide configured to guide the coherent optical signal; and
a beam splitter configured to beam-split the guided coherent optical signal.

13. The method according to claim 11, wherein an array structure of the micro-nano optical diffraction line array is determined by a digital logic operation function corresponding to the predetermined optical diffraction neural network.

14. The method according to claim 13, wherein the array structure of the micro-nano optical diffraction line array is adjusted by one or more of the number of diffraction lines, a spacing between the diffraction lines, a thickness of each diffraction line, a width of each diffraction line, a length of each diffraction line, or a root-mean-square roughness of the thickness, width, and length of each diffraction line.

15. The method according to claim 11, wherein the drive member comprises:
a first drive sub-member configured to generate the first drive signal that drives the laser to generate the coherent optical signal;
a second drive sub-member configured to generate a second drive signal that drives the modulator set to load the digital modulation information;
a third drive sub-member configured to generate a third drive signal that drives the detector array to generate the electrical signal; and
a reading sub-member configured to read the electrical signal from the detector array, and output the operation result based on the electrical signal.

16. The method according to claim 11, wherein at least one modulator is provided in the modulator set.

17. The method according to claim 10, wherein the drive member and the photoelectric integrated member are arranged integrally.

18. The method according to claim 10, wherein a loading timing for loading the digital modulation information by the photoelectric integrated member comprises synchronization and asynchronization.
